(19) United States
(12) Patent Application Publication
(10) Pub. No.: US 2025/0175780 A1
(43) Pub. Date: May 29, 2025

(54) METHOD AND APPARATUS FOR SUPPORTING RESOURCE POOL ALLOCATION FOR SIDELINK DISCOVERY MESSAGE IN WIRELESS COMMUNICATION SYSTEM

(71) Applicant: Samsung Electronics Co., Ltd., Gyeonggi-do (KR)

(72) Inventors: Hyunjeong KANG, Gyeonggi-do (KR); Anil AGIWAL, Gyeonggi-do (KR)

(21) Appl. No.: 18/715,946

(22) PCT Filed: Dec. 16, 2022
(86) PCT No.: PCT/KR2022/020522

§ 371 Date: Jun. 3, 2024

(30) Foreign Application Priority Data
Dec. 20, 2021 (KR) 10-2021-0182780

(51) Int. Cl. H04W 8/00; H04L 1/1812; H04W 72/40; H04W 92/18

(52) U.S. Cl. CPC H04W 8/005; H04L 1/1812; H04W 72/40; H04W 92/18

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The present disclosure can be applied to intelligent services (for example, smart homes, smart buildings, smart cities, smart cars or connected cars, healthcare, digital education, retail businesses, security- and safety-related services, and the like) on the basis of a 5G communication technology and an IoT-related technology. According to various embodiments of the present disclosure, provided may be a method and apparatus for user equipment that receives a configuration and allocation of a transmission resource pool to be used for transmitting a sidelink discovery message in a wireless communication system.

### TECHNICAL FIELD

The present disclosure relates to a wireless communication system. More specifically, it relates to a method and an apparatus for a user equipment and a base station to process a resource pool allocation for transmitting a relay discovery message or a discovery message based on a sidelink in a wireless communication system.

### BACKGROUND ART

In order to meet the increasing demand for wireless data traffic following the commercialization of the 4G (4th generation) communication system, efforts are being made to develop an improved 5G (5th generation) communication system or a pre-5G communication system. For this reason, the 5G communication system or the pre-5G communication system is referred to as a beyond 4G network communication system or a post long term evolution (LTE) system.

In order to achieve a high data rate, the 5G communication system is being considered for implementation in the ultra-high frequency (mmWave) band (e.g., such as 60 GHz band). In order to mitigate the path loss of radio waves in the ultra-high frequency band and increase the transmission distance of radio waves, beamforming, massive MIMO, full dimensional MIMO, FD-MIMO, array antenna, analog beam-forming, and large scale antenna technologies are being discussed in the 5G communication system.

In addition, to improve the network of the system, technologies such as evolved small cells, advanced small cells, cloud radio access networks (cloud RAN), ultra-dense networks, device to device communications (D2D), wireless backhauls, moving networks, cooperative communications, coordinated multi-points (CoMPs), and receiving interference cancellations are being developed in the 5G communication system.

In addition, advanced coding modulation (ACM) methods such as hybrid frequency shift keying and quadrature amplitude modulation (FQAM) and sliding window superposition coding (SWSC), and advanced connection technologies such as filter bank multi carrier (FBMC), non-orthogonal multiple access (NOMA), and sparse code multiple access (SCMA) are being developed in the 5G system.

In the 5G system, support for various services is considered compared to the existing 4G system. For example, the most prominent services may be enhanced mobile broadband (eMBB), ultra-reliable and low latency communication (URLLC), massive machine type communication (mMTC), and evolved multimedia broadcast/multicast service (eMBMS).

In addition, the system providing the URLLC service may be called the URLLC system, and the system providing the eMBB service may be called the eMBB system. In addition, the terms, service and system, can be used interchangeably.

Among them, the URLLC service is a service that is being newly considered in 5G system unlike the existing 4G system, and it requests ultra-high reliability (e.g., packet error rate of about 10-5) and low latency (e.g., about 0.5 msec) compared to other services. In order to meet these stringent requests, URLLC service may request the application of a transmission time interval (TTI) that is shorter than that of eMBB services, and various operational methods using this are being considered.

On the other hand, the Internet is evolving from a human-centered network where humans generate and consume information to an IoT (internet of things) network that exchanges and processes information between distributed components such as objects. An IoE (internet of everything) technology, which combines big data processing technology with IoT technology through connection with cloud servers, etc., is also emerging. In order to realize IoT, technological elements such as sensing technology, wired and wireless communication and network infrastructure, service interface technology, and security technology are requested, and recently, technologies such as sensor network, machine-to-machine (M2M), and MTC (machine type communication) for the connection between objects have been researched.

In the IoT environment, intelligent IT (internet technology) services that create new value in human life by collecting and analyzing data generated from connected objects can be provided. The IoT can be applied to fields such as smart homes, smart buildings, smart cities, smart cars or connected cars, smart grids, health care, smart home appliances, and high-tech medical services through the convergence and combination of existing IT (information technology) technologies and various industries.

Accordingly, various attempts are being made to apply 5G communication systems to IoT networks. For example, technologies such as sensor network, machine-to-machine (M2M), and machine-type communication (MTC) are being implemented by 5G communication technologies such as beamforming, MIMO, and array antennas. The application of cloud radio access network (cloud RAN) as a big data processing technology described above is also an example of the convergence of 5G technology and IoT technology.

In addition, sidelink communication using 5G communication systems is being researched, and it is expected that direct communication between user equipments can be applied to vehicle-to-everything (V2X) and public safety networks, for example, to provide various services to users.

In specific, there is a need to utilize sidelink relays that can support the expansion of service coverage, the increase in the reliability of data transmission, and the reduction of power consumption of user equipments.

### DISCLOSURE OF INVENTION

### Technical Problem

The present disclosure may provide a method and apparatus for allocating a transmission resource pool to transmit a discovery message that is transmitted and received when a user equipment searches for a sidelink relay or a user equipment searches for another user equipment in a wireless communication system.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

According to an embodiment of the present disclosure, in a method for a user equipment to be allocated a transmission resource pool for transmitting a sidelink discovery message in a wireless communication system, the method may include: the user equipment transmitting the transmission model type information and HARQ feedback information for the sidelink discovery message to the base station; the base station determining whether to configure and allocate the resource pool for transmitting the sidelink discovery message to be shared with the general sidelink communication resource pool or to configure and allocate a dedicated transmission resource pool for sidelink discovery purposes; the base station configuring and allocating the sidelink discovery message transmission resource pool to the user equipment; and the user equipment obtaining the sidelink discovery message transmission resource from the allocated sidelink discovery message transmission resource pool.

The present disclosure to solve the problem described above is characterized, in a method performed by the first user equipment in a wireless communication system, to include: receiving a first sidelink discovery message from the second user equipment; determining whether Hybrid Automatic Repeat and request (HARQ) feedback is requested based on the first sidelink discovery message; and transmitting a second sidelink discovery message containing information indicating the HARQ feedback to the second user equipment based on the determination.

In an embodiment, it is characterized to further include the second sidelink discovery message transmitting a first message containing the information on whether the HARQ feedback is requested, to the base station; and receiving a second message containing the resource pool for transmitting the HARQ feedback, from the base station.

In an embodiment, it is characterized that the first message requesting a resource pool for transmitting the first sidelink discovery message is transmitted from the second user equipment to the base station, and the second message including the resource pool is transmitted from the base station to the second user equipment.

In an embodiment, the first message is characterized to further include cast type information.

In addition, in another embodiment of the present disclosure, a method carried out by a second user equipment in a wireless communication system is characterized to include: transmitting a first sidelink discovery message to the first user equipment; receiving a second sidelink discovery message containing information indicating HARQ (Hybrid Automatic Repeat and request) feedback from the first user equipment; and determining whether the HARQ feedback is requested based on the information indicating the HARQ feedback.

In an embodiment, it is characterized to further include transmitting HARQ feedback to the first user equipment based on the information indicating the HARQ feedback.

In an embodiment, it is characterized to further include: transmitting a first message requesting a resource pool to transmit the first sidelink discovery message, to the base station; and receiving a second message containing the resource pool, from the base station.

In addition, in another embodiment of the present disclosure, the first user equipment includes: a transceiver capable of transmitting and receiving at least one signal; and the control unit coupled to the transceiver, wherein the control unit is characterized to be constituted to: receive the first sidelink discovery message from the second user equipment; determine whether a Hybrid Automatic Repeat and request (HARQ) feedback is requested based on the first sidelink discovery message; and transmit the second sidelink discovery message containing information indicating the HARQ feedback to the second user equipment based on the determination.

In addition, in another embodiment of the present disclosure, the second user equipment includes: a transceiver capable of transmitting and receiving at least one signal; and the control unit coupled to the transceiver, wherein the control unit is characterized to be constituted to: transmit a first sidelink discovery message to the first user equipment; receive a second sidelink discovery message containing information indicating the HARQ (Hybrid Automatic Repeat and request) feedback from the first user equipment; and determining whether the HARQ feedback is requested based on the information indicating the HARQ feedback.

### Advantageous Effects of Invention

According to an embodiment of the present disclosure, an apparatus and method that can effectively provide services and expand service coverage in a wireless communication system may be provided.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

FIG. 1a is a diagram illustrating a wireless communication system according to an embodiment of the present disclosure.

FIG. 1b is a diagram illustrating a wireless communication system according to an embodiment of the present disclosure.

FIG. 2 is a diagram illustrating the configuration of a base station in a wireless communication system according to an embodiment of the present disclosure.

FIG. 3 is a diagram illustrating the configuration of a user equipment in a wireless communication system according to an embodiment of the present disclosure.

FIG. 4 is a diagram illustrating the configuration of a communication unit in a wireless communication system according to an embodiment of the present disclosure.

FIG. 5 is a diagram illustrating the structure of time-frequency resources of a wireless communication system according to an embodiment of the present disclosure.

FIG. 6a is a diagram illustrating a sidelink discovery procedure according to an embodiment of the present disclosure.

FIG. 6b is a diagram illustrating a sidelink discovery procedure according to another embodiment of the present disclosure.

FIG. 7 is a diagram illustrating signal flow between a user equipment and a base station that assists in allocating a transmission resource pool for a sidelink discovery message according to an embodiment of the present disclosure.

FIG. 8 is a diagram illustrating the operation of a user equipment that assists in allocating a transmission resource pool for a sidelink discovery message according to an embodiment of the present disclosure.

FIG. 9a is a diagram illustrating the operation of a user equipment to select a transmission resource pool for a sidelink discovery message according to an embodiment of the present disclosure.

FIG. 9b is a diagram illustrating an operation of a user equipment to select a transmission resource pool for a sidelink discovery message according to another embodiment of the present disclosure.

### MODE FOR THE INVENTION

Hereinafter, with reference to the accompanying drawings, the preferred embodiments of the present disclosure are described in detail. At this time, it should be noted that in the accompanying drawing, the same components are represented by the same reference numerals as much as possible. In addition, detailed descriptions of the known functions and configurations that may obscure the gist of the present disclosure will be omitted.

In describing the embodiment in the present specification, the description of technical content that is well known in the technical field to which the present disclosure belongs and that is not directly related to the present disclosure will be omitted. This is to convey the gist of the present disclosure more clearly without obscuring it by omitting unnecessary explanation.

For the same reason, some components in the accompanying drawings are exaggerated, omitted, or schematically shown. Additionally, the size of each component is not entirely a reflection of its actual size. The same or corresponding components in each drawing are assigned the same reference numbers.

The advantages and features of the present disclosure, and the methods of achieving them, will be clarified by reference to the embodiments described in detail below along with the accompanying drawings. However, the present disclosure is not limited to the embodiments disclosed hereinafter, but may be implemented in a variety of different forms, and the present embodiments are provided only to ensure that the disclosure of the present disclosure is complete, and to fully inform the scope of disclosure to persons of ordinary knowledge in the technical field to which the present disclosure pertains, and the present disclosure is only defined by the categories of claims. Throughout the specification, the same reference numerals refer to the same components.

At this time, it will be understood that each block of the processing flowchart illustrations and combinations of the flowchart illustrations may be performed by computer program instructions. These computer program instructions may be mounted on a processor of a general purpose computer, a special purpose computer, or other programmable data processing equipment, such that the instructions, when executed by the processor of the computer or other programmable data processing equipment, create means for performing the functions described in the flowchart block(s). These computer program instructions may be stored in computer-usable or computer-readable memory that may be directed to a computer or other programmable data processing equipment to implement the functions in a specific manner, so that the instructions stored in the computer-usable or computer-readable memory may produce a manufactured item comprising instructional means for performing the functions described in the flowchart block(s). The computer program instructions may also be mounted on a computer or other programmable data processing equipment and a series of operational steps are performed on the computer or other programmable data processing equipment to create a computer-executable process, such that the instructions performing the computer or other programmable data processing equipment may also provide steps for performing the functions described in the flowchart block(s).

In addition, each block may represent a module, a segment, or a portion of code comprising one or more executable instructions for performing a specified logical function(s). It should also be noted that in some alternative embodiments, the functions recited in the blocks may occur out of sequence. For example, two blocks shown one after the other may in fact be performed substantially simultaneously, or the blocks may be performed in reverse order according to the functions they sometimes perform.

At this time, the term ‘˜ part’ used in the present embodiment refers to software or a hardware component such as an FPGA or an ASIC, which may perform any of the roles. However, ‘˜ part’ is not software or hardware specific. It may be configured to reside on an addressable storage medium, or it may be configured to execute one or more processors. Therefore, in one example, ‘˜part’ includes components such as software components, object-oriented software components, class components, and task components, processes, functions, properties, procedures, subroutines, segments of program code, drivers, firmware, microcode, circuits, data, databases, data structures, tables, arrays, and variables. The functionality provided within the components and ‘˜ parts’ may be combined into fewer components and ‘˜ parts’, or further separated into additional components and ‘˜ parts’. Furthermore, the components and ‘˜ parts’ may be implemented to play one or more CPUs within the device or the security multimedia card.

In describing the embodiments of the present disclosure in detail, the main target is the radio area network New RAN (NR) and the core network Packet Core (5G system, or 5G core network, or NG Core: next generation core) on the 5G mobile communication standard specified by the 3rd Generation Partnership Project (3GPP), a mobile communication standards standardization organization, but the main point of the present disclosure is that it can be applied to other communication systems with similar technical backgrounds with slight modifications to the extent that it does not significantly deviate from the scope of the present disclosure, and this will be possible at the discretion of a person with skilled technical knowledge in the technical field of the present disclosure.

In the 5G system, in order to support network automation, a network data collection and analysis function (NWDAF), which is a network function that provides the function of analyzing and providing data collected from the 5G network, can be defined. NWDAF can collect/store/analyze information from the 5G network and provide the results to an unspecified network function (NF), and the analysis results can be used independently by each NF.

For the convenience of explanation below, some of the terms and names defined in the 3GPP standard (5G, NR, LTE or similar system specifications) may be used. However, it is not limited by the terms and names of the present disclosure, and the same may be applied to systems that comply with other standards.

Hereinafter, the present disclosure relates to a method and an apparatus where a user equipment transmitting a sidelink-based discovery message in a wireless communication system receives a configuration and allocation of a discovery message transmission resource pool from a base station. The present disclosure provides a method and an apparatus for obtaining a sidelink discovery message transmission resource pool necessary to transmit a sidelink relay discovery message or a sidelink discovery message for performing a sidelink direct communication with another user equipment in a wireless communication system.

Specifically, the present disclosure provides a way: that the user equipment transmits sidelink discovery type information and HARQ (Hybrid Automatic Repeat and request) feedback information of sidelink discovery messages to the base station; that the base station determines whether to configure and allocate a general sidelink transmission resource pool for a sidelink discovery message or to configure and allocate a transmission resource pool dedicated to a sidelink discovery; and that the user equipment receives a configuration and allocation of a sidelink transmission resource pool to be used to transmit a sidelink discovery message from the base station. According to the embodiments of the present disclosure, the user equipment may extend the service coverage through a sidelink relay or direct communication with another user equipment, increase the reliability of data transmission and reception, and minimize the battery usage of the user equipment.

In the following description, terms referring to signals, terms referring to channels, terms referring to control information, terms referring to network entities, terms referring to device components, etc. are illustrated for convenience of explanation. Therefore, it is not limited to the terms used in the present disclosure, and other terms referring to objects having equivalent technical meaning may be used.

Hereinafter, the base station may be at least one of gNode B, eNode B, Node B, base station (BS), wireless access unit, base station controller, or node on the network as the entity that performs the resource allocation of the user equipment. User equipment may include a user equipment (UE), a mobile station (MS), a cellular phone, a smartphone, a computer, or a multimedia system capable of performing communication functions. However, this is only one example, and base stations and user equipment are not limited to these examples. In the present disclosure, eNB may be used interchangeably with gNB for convenience of explanation. That is, a base station described as an eNB may represent a gNB. In the present disclosure, the term user equipment may refer to a variety of wireless communication devices as well as mobile phones, NB-IoT devices, and sensors.

In the following description, physical channels and signals may be used interchangeably with data or control signals. For example, PDSCH (physical downlink shared channel) is a term used to refer to the physical channel through which data is transmitted, but PDSCH may also be used to refer to data. That is, in the present disclosure, the expression ‘transmitting a physical channel’ may be interpreted as equivalent to ‘transmitting data or signals through a physical channel’.

Hereinafter, in the present disclosure, upper layer signaling means a method of transmitting signals from the base station to the user equipment using the downlink data channel of the physical layer, or from the user equipment to the base station using the uplink data channel of the physical layer. The upper layer signaling may be understood as radio resource control (RRC) signaling or media access control (MAC) control element (CE).

In addition, in the present disclosure, the expression ‘greater than or less than’ is used to determine whether a specific condition is satisfied or fulfilled, but this is only for the purpose of expressing an example and does not exclude the description of ‘greater than or equal to, or less than or equal to’. Conditions listed as ‘greater than or equal to’ may be replaced by ‘greater than’, conditions listed as ‘less than or equal to’ may be replaced by ‘less than’, and conditions listed as ‘greater than or equal to, or less than’ may be replaced by ‘greater than, or less than or equal to’.

In addition, the present disclosure describes some embodiments using terminology used in some telecommunications standards (e.g., 3rd Generation Partnership Project (3GPP)), but this is only an example for explanation. Embodiments of the present disclosure may be easily modified and applied in other communication systems.

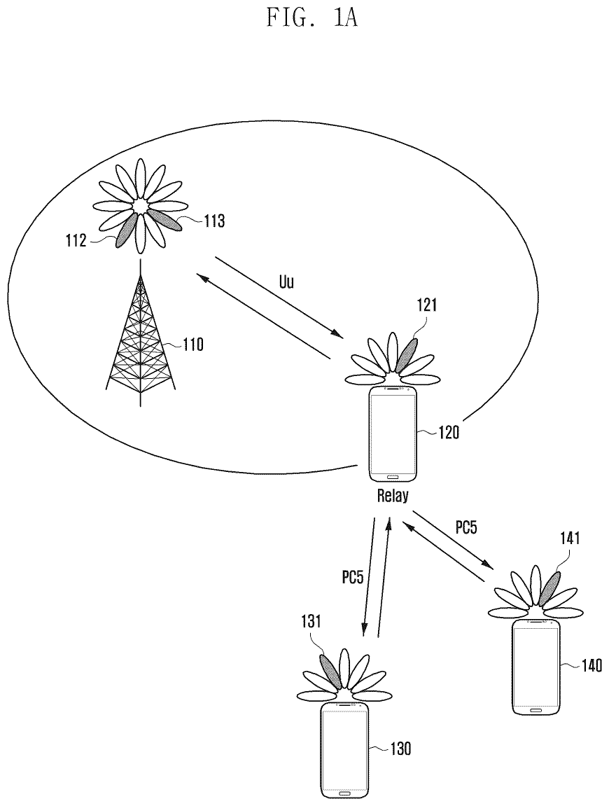

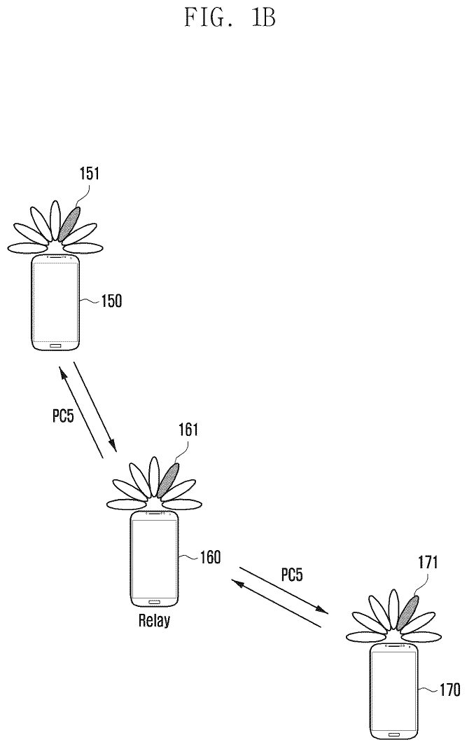

FIG. 1a is a diagram illustrating a wireless communication system according to an embodiment of the present disclosure.

FIG. 1a illustrates a base station 110, user equipments 130 and 140, and a sidelink relay 120 that can relay the transmission and reception of data between the base station and the user equipment, as a part of the nodes that use the wireless channel in the wireless communication system. Here, the sidelink relay corresponds to the U2N (UE to network) relay. FIG. 1a illustrates only one base station, but other base stations identical or similar to the base station 110 may be further included.

The base station 110 is a network infrastructure that provides wireless access to the user equipments 130 and 140 and the replay 120. The base station 110 has coverage defined as a certain geographic area based on the distance at which the signal can be transmitted. The base station 110 may be referred to as an ‘access point (AP)’, ‘eNodeB, eNB’, ‘5th generation node’, ‘next generation nodeB (gNB)’, ‘wireless point’, ‘transmission/reception point (TRP)’ or other terms with equivalent technical meanings in addition to the base station.

The relay 120 may communicate with the base station 110 through a wireless channel as a device used by a user or a network infrastructure. The link from the base station 110 to the relay 120 may be referred to as downlink (DL), and the link from the relay 120 to the base station 110 may be referred to as uplink (UL). The base station 110 and the relay 120 may be connected through the Uu interface. Uplink (UL) refers to a wireless link in which the relay 120 transmits data or control signals to the base station 110, and downlink (DL) refers to a wireless link in which the base station 110 transmits data or control signals to the relay 120.

The relay 120 may communicate with the user equipment 130 and the user equipment 140 through a wireless channel. At this time, the link between the relay 120 and the user equipment 130 and the link between the relay 120 and the user equipment 140 are referred to as a sidelink, and the sidelink may be referred to as a PC5 interface.

Each of the user equipments 130 and 140 as a device used by a user may perform communication with the base station 110 through a wireless channel, or perform communication with the network through a relay 120 and a wireless channel. In the present disclosure, each of the user equipment 130 and user equipment 140 is illustrated only when performing communication through a wireless channel with a relay 120. At least one of the user equipment 130 and the user equipment 140 may operate without user involvement. That is, at least one of the user equipment 130 and the user equipment 140 may be a device that performs machine type communication (MTC) and may not be carried by a user. Each of the user equipment 130 and the user equipment 140 may be referred to as a “user equipment (UE)”, “mobile station”, “subscriber station”, “remote terminal”, “wireless terminal”, or “user device”, or any other term having an equivalent technical meaning, in addition to terminal.

FIG. 1b is a diagram illustrating a wireless communication system according to an embodiment of the present disclosure.

FIG. 1b depicts a wireless communication system including user equipment 150 and 170 and a sidelink relay 160 capable of relaying data transmission and reception between user equipments as a part of the nodes that use a wireless channel in the wireless communication system. Here, the sidelink relay 160 corresponds to a U2U (UE to UE) relay.

The relay 160 may communicate with the user equipment 150 and user equipment 170 through a wireless channel. At this time, the link between the relay 160 and the user equipment 150 and the link between the relay 160 and the user equipment 170 are referred to as sidelinks, and the sidelink may be referred to as a PC5 interface.

Each of the user equipment 150 and user equipment 170 as a device used by the user may perform communication directly through a wireless channel or may perform communication with the other user equipment through a relay 160 and a wireless channel. At this time, the link between the user equipment 150 and the user equipment 170, the link between the user equipment 150 and the relay 160, and the link between the user equipment 170 and the relay 160 are referred to as side links, and the side link may be referred to as a PC5 interface.

At least one of the user equipment 150 and the user equipment 170 may be operated without the user involvement. In other words, at least one of the user equipment 150 and the user equipment 170 is a device that performs machine type communication (MTC) and may not be carried by the user. Each of the user equipment 150 and the user equipment 170 may be referred to as ‘user equipment’ (UE)′, ‘mobile station’, ‘subscriber station’, ‘remote terminal’, ‘wireless terminal’, or ‘user device’ or other terms having an equivalent technical meaning in addition to terminal.

In the following description, uplink or downlink and Uu interface, sidelink and PC-5 may be used interchangeably.

The base station 110, relays 120 and 160, and user equipments 130, 140, 150, and 170 illustrated in FIGS. 1a and 1b may transmit and receive wireless signals in a millimeter wave (mmWave) band (e.g., 28 GHz, 30 GHz, 38 GHz, 60 GHz). At this time, to improve channel gain, the base station 110, relays 120 and 160, and user equipments 130, 140, 150, and 170 may perform beamforming. Here, beamforming may include transmission beamforming and reception beamforming. That is, the base station 110, the relays 120 and 160, and the user equipments 130, 140, 150, and 170 may give directivity to the transmitted or received signals. To do so, the base station 110, the relays 120 and 160, and the user equipments 130, 140, 150, and 170 may select serving beams 112, 113, 121, 131, 141, 151, 161, and 171 through a beam search or beam management procedure.

After the serving beams 112, 113, 121, 131, 141, 151, 161, and 171 are selected, communication may be performed through a resource that is in a quasi co-located (QCL) relationship with the resource that transmitted the serving beams 112, 113, 121, 131, 141, 151, 161, and 171.

If the large-scale features of the channel that carried the symbol on the first antenna port can be inferred from the channel that carried the symbol on the second antenna port, then the first antenna port and the second antenna port may be evaluated as having a QCL relationship. For example, a wide range of features may include at least one of the following: delay spread, doppler spread, doppler shift, average gain, average delay, and spatial receiver parameter.

The user equipment 130, user equipment 140, user equipment 150, and user equipment 170 illustrated in FIGS. 1a and 1b may support vehicle communications. In the case of vehicle communication, standardization work on vehicle to everything (V2X) technology based on a device-to-device (D2D) structure in LTE systems was completed in 3GPP Releases 14 and 15, and standardization work on V2X technology based on 5G NR was completed in 3GPP Release 16. NR V2X supports unicast, groupcast (or multicast), and broadcast communication between user equipments. In addition, NR V2X aims to provide more advanced services such as platooning, advanced driving, extended sensor, and remote driving, unlike LTE V2X, which is aimed at transmitting and receiving basic safety information necessary for vehicles to drive on the road. V2X services may be categorized into basic safety services and advanced services. Basic safety services may include detailed services such as left turn notification service, frontal collision warning service, emergency vehicle approach notification service, front obstacle warning service, intersection signal information service, etc, as well as vehicle notification (cooperative awareness messages (CAM) or basic safety message (BSM)) services, and V2X information can be transmitted and received using broadcast, unicast, or groupcast transmission methods. Advanced services have higher quality of service (QOS) requests than basic safety services and request V2X information to be transmitted and received using unicast and groupcast transmission methods in addition to broadcast to transmit and receive V2X information within a specific group of vehicles or to transmit and receive V2X information between two vehicles. The advanced services may include detailed services such as clustered driving services, autonomous driving services, remote driving services, and extended sensor-based V2X services. NR V2X may also provide public safety services by supporting direct communication services between user equipments in areas without network infrastructure.

Hereinafter, the sidelink (SL) refers to a transmission and reception path for signals between a user equipment and a user equipment or a transmission and reception path for signals between user equipments and relays, which may be used interchangeably with PC5 interface. Hereinafter, the base station may be a base station that supports both V2X communication and conventional cellular communication, or a base station that supports V2X communication only, as an entity that performs resource allocation for user equipments and relays. That is, a base station may mean an NR base station (e.g., gNB), an LTE base station (e.g., eNB), or a road site unit (RSU). A terminal may include all not only a typical user equipment and a mobile station, but also a vehicle supporting vehicle-to-vehicle (V2V) communication, a handset (e.g., a smartphone) of a vehicle or a pedestrian supporting vehicle-to-pedestrian (V2P) communication, a vehicle supporting vehicle-to-network (V2N) communication, or a vehicle supporting vehicle-to-infrastructure (V2I) communication, and an RSU equipped with user equipment functionality, an RSU equipped with base station functionality, or an RSU equipped with some of the base station functionality and some of the user equipment functionality.

On the other hand, in the present disclosure, a user equipment may mean a vehicle that supports vehicular-to-vehicular communication (V2V), a vehicle or a pedestrian handset (e.g., a smartphone) that supports vehicular-to-pedestrian communication (V2P), a vehicle that supports vehicular-to-network (V2N), or a vehicle that supports communication between a vehicle and infrastructure (V2I). A user equipment may refer to a user device that supports communication between devices in the public safety network.

In addition, in the present disclosure, a user equipment may mean a road side unit (RSU) equipped with a user equipment function, an RSU equipped with a base station function, or an RSU equipped with a part of a base station function and a part of a user equipment function.

In the present disclosure, a relay may mean a vehicle that supports V2X communication or a user device that supports communication between devices in the public safety network. In addition, in the present disclosure, the relay may mean a device equipped with a user equipment function, a device equipped with a base station function, or a device equipped with a part of a user equipment function and a part of a base station function.

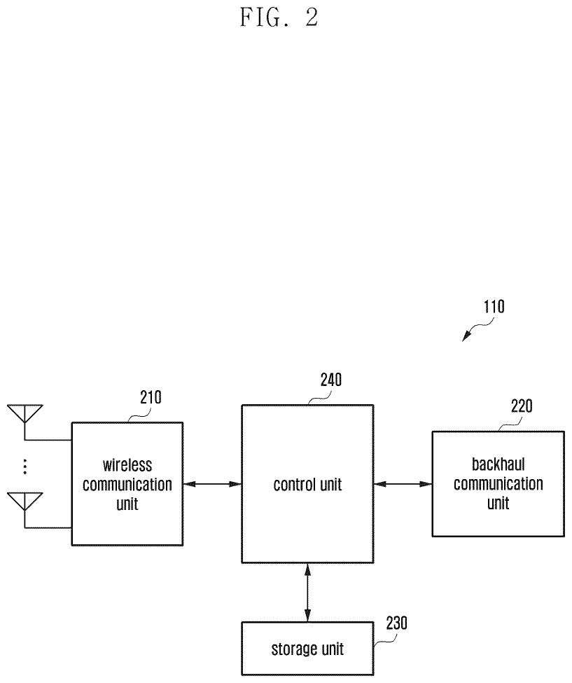

FIG. 2 is a diagram illustrating the configuration of a base station in a wireless communication system according to an embodiment of the present disclosure.

The configuration illustrated in FIG. 2 may be understood as the configuration of the base station 110. Terms ‘ . . . part’ and ‘ . . . unit’ used hereinafter mean a unit that processes at least one function or operation, which can be implemented by hardware or software, or a combination of hardware and software.

With reference to FIG. 2, the base station 110 may include the wireless communication unit 210, the backhaul communication unit 220, the storage unit 230, and the control unit 240. However, the components of the base station 110 are not limited to the aforementioned examples. For example, the base station may contain more or fewer components than the aforementioned components. In addition, the wireless communication unit 210, the backhaul communication unit 220, the storage unit 230, and the control unit 240 may be implemented in the form of a single chip. In addition, the control unit 240 may include one or more processors.

The wireless communication unit 210 may perform functions for transmitting and receiving signals through a wireless channel. For example, the wireless communication unit 210 may perform a conversion function between a baseband signal and a bit sequence according to the physical layer specifications of the system. For example, when transmitting data, the wireless communication unit 210 may generate complex symbols by encoding and modulating the transmission bit sequence. In addition, when receiving data, the wireless communication unit 210 may restore the received bit sequence by demodulating and decoding the baseband signal.

In addition, the wireless communication unit 210 up-converts the baseband signal into an RF (radio frequency) band signal and transmits it through an antenna, and down-converts the RF band signal received through the antenna into a baseband signal. For this purpose, the wireless communication unit 210 may include a transmission filter, a reception filter, an amplifier, a mixer, an oscillator, a digital to analog convertor (DAC), an analog to digital convertor (ADC), etc. Additionally, the wireless communication unit 210 may include a plurality of transmission and reception paths. Furthermore, the wireless communication unit 210 may include at least one antenna array composed of a plurality of antenna elements.

In terms of hardware, the wireless communication unit 210 may be composed of a digital unit and an analog unit, and the analog unit may be composed of a plurality of sub-units according to operating power, operating frequency, etc. A digital unit may be implemented with at least one processor (e.g., a digital signal processor (DSP)).

The wireless communication unit 210 transmits and receives the signal as described above. Accordingly, all or part of the wireless communication unit 210 may be referred to as a ‘transmitter’, ‘receiver’ or ‘transceiver’. Additionally, in the following description, transmission and reception through a wireless channel are used to mean that the processing as described above is performed by the wireless communication unit 210.

The backhaul communication unit 220 may provide an interface for communicating with other nodes in the network. That is, the backhaul communication unit 220 may convert the bit sequence transmitted from the base station 110 to another node, for example, another connection node, another base station, a parent node, a core network, etc., into a physical signal, and convert the physical signal received from the other node into a bit sequence.

The storage unit 230 may store data such as basic programs, applications, and configuration information for the operation of base station 110. The storage unit 230 may be comprised of volatile memory, non-volatile memory, or a combination of volatile and non-volatile memory. And the storage unit 230 may provide the stored data upon request of the control unit 240.

The control unit 240 may control the overall operation of base station 110. For example, the control unit 240 may transmit and receive signals through the wireless communication unit 210 or through the backhaul communication unit 220. In addition, the control unit 240 writes and reads data to the storage unit 230. In addition, the control unit 240 may perform the functions of the protocol stack requested by the communication standard. According to another implementation example, the protocol stack may be included in the wireless communication unit 210. For this purpose, the control unit 240 may include at least one processor. According to some embodiments, the control unit 240 may control the base station 110 to perform the operations described in the following embodiments.

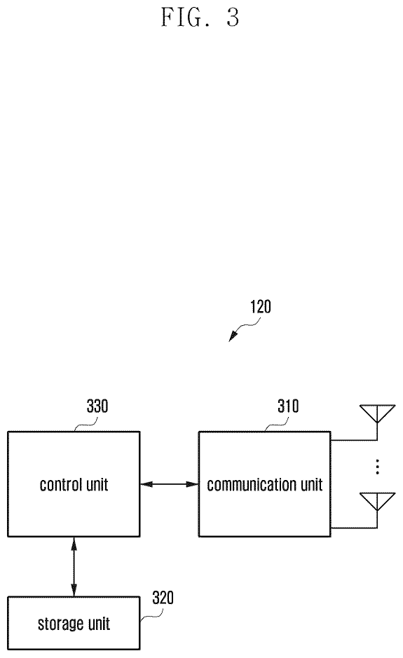

FIG. 3 is a diagram illustrating the configuration of a user equipment in a wireless communication system according to an embodiment of the present disclosure.

The configuration shown in FIG. 3 may be understood as the configuration of the user equipment 120. Terms ‘ . . . part’ and ‘ . . . unit’ used hereinafter mean a unit that processes at least one function or operation, which can be implemented by hardware or software, or a combination of hardware and software.

With reference to FIG. 3, the user equipment 120 may include the communication unit 310, the storage unit 320, and the control unit 330. However, the components of the user equipment 120 are not limited to the aforementioned examples. For example, the user equipment 120 may contain more or fewer components than the aforementioned components. In addition, the communication unit 310, the storage unit 320, and the control unit 330 may be implemented in the form of a single chip. In addition, the control unit 330 may include one or more processors.

The communication unit 310 may perform functions for transmitting and receiving signals through a wireless channel. For example, the communication unit 310 may perform a conversion function between a baseband signal and a bit sequence according to the physical layer specifications of the system. For example, when transmitting data, the communication unit 310 may generate complex symbols by encoding and modulating the transmission bit sequence. In addition, when receiving data, the communication unit 310 may restore the received bit sequence by demodulating and decoding the baseband signal. In addition, the communication unit 310 up-converts the baseband signal into an RF (radio frequency) band signal and transmits it through an antenna, and down-converts the RF band signal received through the antenna into a baseband signal. For example, the communication unit 310 may include a transmission filter, a reception filter, an amplifier, a mixer, an oscillator, a DAC, an ADC, etc.

Additionally, the communication unit 310 may include a plurality of transmission and reception paths. Furthermore, the communication unit 310 may include at least one antenna array composed of a plurality of antenna elements. In terms of hardware, the communication unit 310 may be composed of a digital circuit and an analog circuit (e.g., radio frequency integrated circuit (RFIC)). Here, the digital circuit and the analog circuit may be implemented as a single package. In addition, the communication unit 310 may include multiple RF chains. Further, the communication unit 310 may perform beamforming.

The communication unit 310 may transmit and receive the signal as described above. Accordingly, all or part of the communication unit 310 may be referred to as a ‘transmitter’, ‘receiver’ or ‘transceiver’. Additionally, in the following description, transmission and reception through a wireless channel are used to mean that the processing as described above is performed by the communication unit 310.

The storage unit 320 may store data such as basic programs, applications, and configuration information for the operation of the user equipment 120. The storage 320 may be comprised of volatile memory, non-volatile memory, or a combination of volatile and non-volatile memory. And the storage unit 320 provides the stored data upon the request of the control unit 330.

The control unit 330 controls the overall operation of the user equipment 120. For example, the control unit 330 may transmit and receive signals through the communication unit 310. In addition, the control unit 330 writes and reads data to the storage unit 320. In addition, the control unit 330 may perform the functions of the protocol stack requested by the communication standard. For this purpose, the control unit 330 may contain at least one processor or microprocessor, or may be part of a processor. In addition, a part of the communication unit 310 and the control unit 330 may be referred to as the communication processor (CP). According to some embodiments, the control unit 330 may control the user equipment 1200 to perform the operations described in the following embodiments.

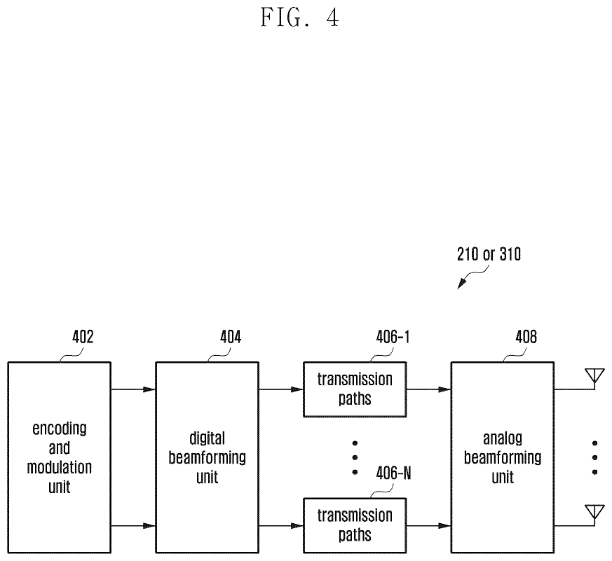

FIG. 4 is a diagram illustrating the configuration of a communication unit in a wireless communication system according to an embodiment of the present disclosure.

FIG. 4 illustrates an example of the detailed configuration of the wireless communication unit 210 of FIG. 2 or the communication unit 310 of FIG. 3. Specifically, FIG. 4 illustrates components for performing beamforming as part of the wireless communication unit 210 of FIG. 2 or the communication unit 310 of FIG. 3.

With reference to FIG. 4, the wireless communication unit 210 or communication unit 310 may include encoding and modulation unit 402, a digital beamforming unit 404, a plurality of transmission paths 406-1 to 406-N, and an analog beamforming unit 408.

The encoding and modulation unit 402 may perform channel encoding. For channel encoding, at least one of a low density parity check (LDPC) code, a convolution code, and a polar code may be used. The encoding and modulation unit 402 generates modulation symbols by performing constellation mapping.

The digital beamforming unit 404 may perform beamforming on digital signals (e.g., modulating symbols). For this purpose, the digital beamforming unit 404 multiplies the modulation symbols by the beamforming weights. Here, beamforming weights are used to change the magnitude and phase of the signal, and may be referred to as a ‘precoding matrix’, ‘precoder’, etc. The digital beamforming unit 404 may output digitally beamformed modulation symbols to a plurality of transmission paths 406-1 to 406-N. At this time, according to the multiple input multiple output (MIMO) transmission technique, the modulation symbols may be multiplexed, or the same modulation symbols may be provided to a plurality of transmission paths 406-1 to 406-N.

The plurality of transmission paths (406-1 to 406-N) may convert digitally beamformed digital signals into analog signals. For this purpose, each of the plural transmission paths (406-1 to 406-N) may include an inverse fast fourier transform (IFFT) operation unit, a cyclic prefix (CP) insertion unit, a DAC, and an upconversion unit. The CP insertion is intended for orthogonal frequency division multiplexing (OFDM) method, which may be excluded if other physical layer methods (e.g., filter bank multi-carrier (FBMC)) are applied. That is, the plurality of transmission paths (406-1 to 406-N) may provide an independent signal processing process for a plurality of streams generated through digital beamforming. However, depending on the implementation method, some of the components of the plurality of transmission paths (406-1 to 406-N) may be commonly used.

The analog beamforming unit 408 may perform beamforming on the analog signals. For this purpose, the digital beamforming unit 404 may multiply the analog signals by the beamforming weights. Here, beamforming weights are used to change the magnitude and phase of the signal. Specifically, depending on the connection structure between the plurality of transmission paths 406-1 to 406-N and the antennas, the analog beamforming unit 440 may be configured in various ways. For example, each of the plurality of transmission paths 406-1 to 406-N may be connected to one antenna array. As another example, a plurality of transmission paths 406-1 to 406-N may be connected to one antenna array. As another example, the plurality of transmission paths 406-1 to 406-N may be adaptively connected to one antenna array or may be connected to two or more antenna arrays.

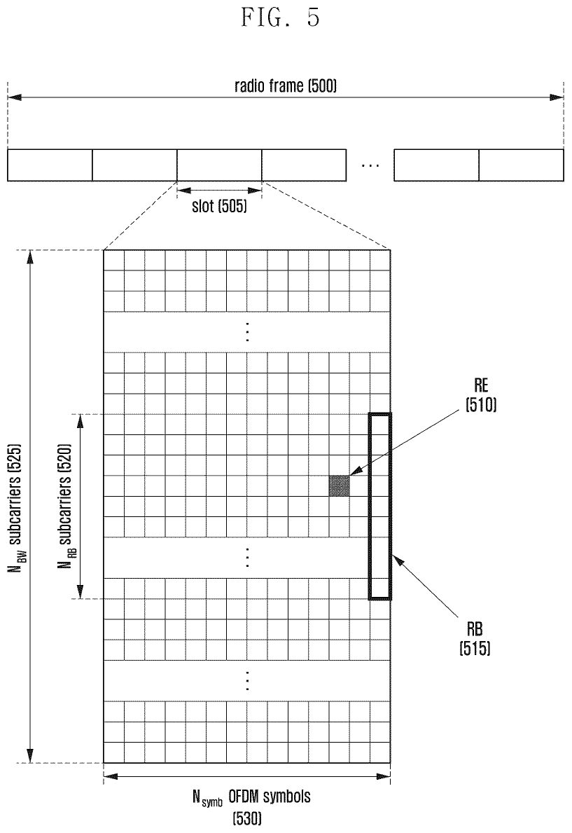

FIG. 5 is a diagram illustrating the structure of time-frequency resources of a wireless communication system according to an embodiment of the present disclosure.

With reference to FIG. 5, in the radio resource domain, the horizontal axis represents the time domain, and the vertical axis represents the frequency domain. The minimum transmission unit in the time domain is the OFDM symbol or the DFT-S-OFDM symbol, which may contain N_{symb} OFDM symbols or DFT-S-OFDM symbols 530 in one slot 505. Unlike slots, in NR systems, the length of the subframe may be defined as 1.0 ms, and the length of the radio frame 500 may be defined as 10 ms. The minimum transmission unit in the frequency domain is the subcarrier, and the bandwidth of the total system transmission bandwidth may include a total of N_{BW} subcarriers 525. Specific figures such as N_{symb} and N_{BW} may be applied variably depending on the system.

The basic unit of the time-frequency resource domain is a resource element (RE) 510, which may be represented by the OFDM symbol index or the DFT-S-OFDM symbol index and subcarrier index. The resource block (RB) 515 may be defined as N_{RB} consecutive subcarriers 520 in the frequency domain. In general, the minimum data transmission unit is the RB unit, and, in general, in NR systems N_{symb}=14 and N_{RB}=12.

The structure of the time-frequency resource as shown in FIG. 5 may be applied to the Uu interface. In addition, the time-frequency resource structure shown in FIG. 5 may be similarly applied to sidelinks.

A sidelink relay may be authenticated to be used in at least one of a specific service, a specific user equipment, a specific sidelink flow, a specific sidelink bearer, a specific unicast link, a specific source identifier, and a specific destination identifier. The sidelink relay may configure a direct connection with the authenticated user equipment at the time of installation. In an embodiment, the sidelink relay may transmit a sidelink relay discovery message and perform a procedure to configure a sidelink direct connection with the authenticated user equipment. In another embodiment, the sidelink relay may receive a sidelink relay discovery message from an authenticated user equipment, transmit a sidelink relay discovery message to the authenticated user equipment, and perform a procedure to configure a sidelink direct connection with the corresponding user equipment. In various embodiments, a sidelink relay discovery message may be understood as a message transmitted to each other to initiate a sidelink relay discovery procedure between a sidelink relay and a user equipment, and may include a message for discovery or a message for a request for discovery. The configuration information requested for the sidelink relay user equipment and the sidelink remote user equipment to transmit or receive the sidelink relay discovery message may be obtained from the base station or may be preconfigured.

A user equipment may be authenticated to be used for a direct sidelink connection in at least one of a specific service, a specific user equipment, a specific sidelink flow, a specific sidelink bearer, a specific unicast link, a specific source identifier, and a specific destination identifier. In an embodiment, the user equipment may transmit a sidelink discovery message to search for another user equipment that can perform a sidelink direct connection configuration, and perform a sidelink direct connection configuration procedure with the authenticated user equipment. In another embodiment, the user equipment may receive a sidelink discovery message from the authenticated user equipment, transmit a sidelink discovery message to the authenticated user equipment, and perform a procedure to configure a sidelink direct connection with the corresponding authenticated user equipment.

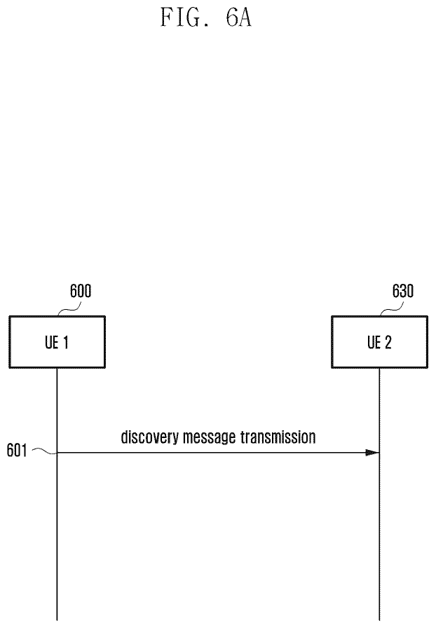

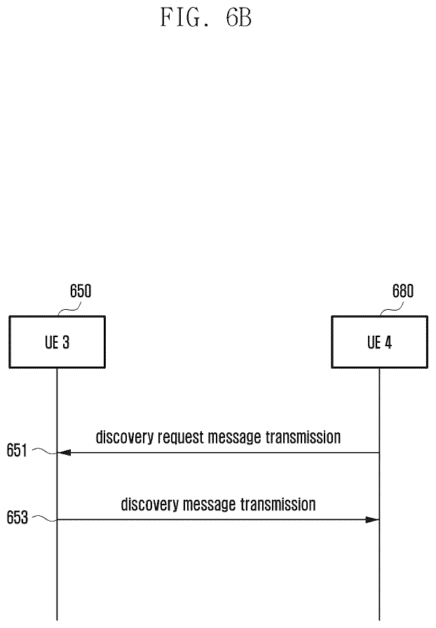

Next, the sidelink discovery procedure will be described with reference to FIGS. 6a and 6b. The sidelink discovery procedure of FIGS. 6a to 6b may be applied to a UE-to-network (UE2NW) relay discovery procedure, a UE-to-UE (UE2UE) relay discovery procedure, or a sidelink discovery procedure between user equipments.

FIG. 6a is a diagram illustrating a sidelink discovery procedure according to an embodiment of the present disclosure.

With reference to FIG. 6a, UE1 600 illustrates a relay user equipment (relay UE) that functions as a sidelink relay, and UE2 630 illustrates a remote UE that performs data transmission and reception with a base station or other user equipments through the support of sidelink relay. UE1 600 may obtain the authentication information or service information requested for the relay role. The authentication or service information requested for the relay role may be obtained through the core network or through operations, administration and management (OAM) methods. UE2 630 may obtain authentication information or service information requested for the remote user equipment role. The authentication information or service information requested for the remote user equipment role may be obtained through the core network or OAM method. The authentication information or service information requested for the relay user equipment and remote user equipment roles may include the information in Table 1 below.

TABLE 1
The following information is provisioned in the UE in support of the UE assuming the role
of a 5G ProSe UE-to-Network Relay:

| 1) | Authorisation policy for acting as a 5G ProSe Layer-3 and/or Layer-2 UE-to-Network Relay when | |
|---|---|---|
| | “served by NG-RAN”: | |
| | - | PLMNs in which the UE is authorized to relay traffic for 5G ProSe Layer-3 and/or Layer-2 |
| | | Remote UEs. |
| 2) | ProSe Relay Discovery policy/parameters for 5G ProSe UE-to-Network Relay: | |
| | - | Includes the parameters that enable the UE to perform 5G ProSe UE-to-Network Relay Discovery |

| when provided by PCF or provisioned in the ME or configured in the UICC: | |
|---|---|
| - | 5G ProSe UE-to-Network Relay Discovery parameters (User Info ID, Relay Service Code(s), |
| | UE-to-Network Relay Layer Indicator(s)); the UE-to-Network Relay Layer Indicator indicates |
| | whether a particular RSC is offering 5G ProSe Layer-2 or Layer-3 UE-to-Network Relay |
| | service. |
| - | Default Destination Layer-2 ID(s) for sending and receiving initial signaling of discovery |
| | messages; |
| - | For 5G ProSe Layer 3 UE-to-Network Relay, the PDU Session parameters (PDU Session type, |
| | DNN, SSC Mode, S-NSSAI, Access Type Preference) to be used for the relayed traffic for |
| | each ProSe Relay Service Code; |
| - | Includes security related content for 5G ProSe Relay UE-to-Network Discovery for each ProSe |

| | |
|---|---|
| | Relay Service Code. |
| NOTE 1: | 5G ProSe Relay Discovery policy parameters can be provided from ProSe Application Server |
| | to the 5G ProSe UE-to-Network Relay. |

| 3) | For 5G ProSe Layer 3 UE-to-Network Relay, QoS mapping(s): | |
|---|---|---|
| | - | Each QoS mapping entry includes: |

| - | a mapping between a 5QI value and a PQI value; |
|---|---|
| - | a PQI PDB adjustment factor, for the PC5 communication for the 5G ProSe Layer-3 UE-to- |
| | Network Relay operation; |
| - | optional the Relay Service Code(s) associates with the QoS mapping entry. |

| 4) | For 5G ProSe Layer 3 UE-to-Network Relay to relay Ethernet or Unstructured traffic from 5G ProSe | |
|---|---|---|
| | Layer-3 Remote UE by using IP type PDU Session, | |
| | - | Mapping of ProSe Service(s) to ProSe Application Server address information (consisting of IP |

address FQDN and transport layer port number).

The following information is provisioned in the UE in support of the UE assuming the role
of a 5G ProSe Remote UE and thereby enabling the use of a 5G ProSe UE-to-Network Relay:

| 1) | Authorisation policy for using a 5G ProSe Layer-3 and/or Layer-2 UE-to-Network Relay: | |
|---|---|---|
| | - | Indicates whether the UE is authorised to use a 5G ProSe Layer-3 and/or Layer-2 UE-to-Network |
| | | Relay. |
| 2) | Policy/parameters for 5G ProSe UE-to-Network Relay Discovery: | |
| | - | Includes the parameters for 5G ProSe Relay Discovery and for enabling the UE to connect to the |

| 5G ProSe UE-to-Network Relay after discovery when provided by PCF or provisioned in the ME | |
|---|---|
| or configured in the UICC: | |
| - | 5G ProSe UE-to-Network Relay Discovery parameters (User Info ID, Relay Service Code(s), |
| | UE-to-Network Relay Layer indicator(s)); the UE-to-Network Relay Layer Indicator indicates |
| | whether a particular RSC is offering 5G ProSe Layer-2 or Layer-3 UE-to-Network Relay |
| | service. |
| - | Default Destination Layer-2 ID(s) for sending and receiving initial signaling of discovery |
| | messages; |
| - | For 5G ProSe Layer-3 UE-to-Network Relay, the PDU Session parameters (PDU Session type, |
| | DNN, SSC Mode, S-NSSAI, Access Type Preference) to be used for the relayed traffic without |
| | using N3IWF access, or an indication of N3IWF access, for each ProSe Relay Service Code; |
| - | Includes security related content for 5G ProSe UE-to-Network Relay Discovery for each ProSe |

Relay Service Codes.

| 3) | Policy parameters for N3IWF selection for 5G ProSe Layer-3 Remote UE: | |
|---|---|---|
| | - | N3IWF identifier configuration for 5G ProSe Layer-3 Remote UE (either FQDN or IP address) in |
| | | the HPLMN. |
| | - | 5G ProSe Layer-3 UE-to-Network Relay access node selection information - a prioritized list of |

PLMNs for N3IWF selection. It also indicates if selection of an N3IWF in a PLMN should be
based on Tracking Area Identity FQDN or on Operator Identifier FQDN.

| | |
|---|---|
| NOTE 2: | ProSe Relay Discovery policy/parameters can be provided from ProSe Application Server to |
| | the 5G ProSe Remote UE. |

The following information is provisioned in the UE in support of the UE assuming the role
of a 5G ProSe UE-to-Network Relay as well as in the UE in support of the UE assuming the
role of a 5G ProSe Remote UE and thereby enabling the use of a 5G ProSe UE-to-Network
Relay:

| 1) | Radio parameters for 5G ProSe UE-to-Network Relay Discovery when the UE is not “served by NG- | |
|---|---|---|
| | RAN”: | |
| | - | Includes the radio parameters NR PC5 with Geographical Area(s) and an indication of whether |
| | | they are “operator managed” or “non-operator managed”. The UE uses the radio parameters to |
| | | perform 5G ProSe Direct Discovery over PC5 reference point when “not served by NG-RAN” |
| | | only if the UE can reliably locate itself in the corresponding Geographical Area. Otherwise, the UE |
| | | is not authorized to transmit. |
| 2) | Radio parameters for 5G ProSe Relay UE-to-Network Communication when the UE is not “served by | |
| | NG-RAN”: | |
| | - | Includes the radio parameters NR PC5 with Geographical Area(s) and an indication of whether |

they are “operator managed” or “non-operator managed”. The UE uses the radio parameters to
perform 5G ProSe Direct Communication over PC5 reference point when “not served by NG-
RAN” only if the UE can reliably locate itself in the corresponding Geographical Area. Otherwise,
the UE is not authorized to transmit.

Alternatively, UE1 600 and UE2 630 illustrate the source user equipment and target user equipment of the sidelink discovery procedure, respectively. UE1 600 and UE2 630 may obtain authentication or service information requested for sidelink discovery procedures through a core network or OAM method. Authentication information or service information that can perform the sidelink discovery procedure may include the information in Table 2 below.

TABLE 2
The following sets of information for 5G ProSe Direct Discovery over PC5 reference point
is provisioned to the UE:

| | |
|---|---|
| 1) | Authorization policy for 5G ProSe Direct Discovery: |
| - | When the UE is “served by NG-RAN”: |
| - | For open 5G ProSe Direct Discovery: |
| a) | open 5G ProSe Direct Discovery Model A monitoring authorization policy: |
| - | PLMNs in which the UE is authorised to perform 5G ProSe Direct Discovery |
| monitoring. | |
| b) | open 5G ProSe Direct Discovery Model A announcing authorization policy: |
| - | PLMNs in which the UE is authorized to perform announcing; |
| - | Authorised discovery range for announcing per PLMN. |
| - | For restricted 5G ProSe Direct Discovery: |
| a) | restricted 5G ProSe Direct Discovery Model A monitoring authorization policy: |
| - | PLMNs in which the UE is authorised to perform restricted 5G ProSe Direct Discovery |

Model A monitoring.

| | |
|---|---|
| b) | restricted 5G ProSe Direct Discovery Model A announcing authorization policy: |
| - | PLMNs in which the UE is authorized to perform restricted 5G ProSe Direct Discovery |

Model A announcing;

| | |
|---|---|
| - | Authorised discovery range for announcing per PLMN. |
| c) | restricted 5G ProSe Direct Discovery Model B Discoverer operation authorization |

policy:

| | |
|---|---|
| - | PLMNs in which the UE is authorized to perform Model B Discoverer operation; |
| - | Authorised discovery range for announcing per PLMN. |
| d) | restricted 5G ProSe Direct Discovery Model B Discoveree operation authorization |

policy:

| | |
|---|---|
| - | PLMNs in which the UE is authorized to perform Model B Discoveree operation; |
| - | Authorised discovery range for announcing per PLMN. |

The UE1 600 may transmit a sidelink discovery message, for example, a first message, in step 601. The sidelink discovery message (first message) transmitted by the UE1 600 according to the embodiment of FIG. 6a may include, for example, a discovery message. In various embodiments, the first message may include information indicating the existence of a sidelink relay, information about a service message, or the like. The UE1 600 may obtain configuration information necessary to transmit the sidelink discovery message. The configuration information requested to transmit the sidelink discovery message may include at least one of a transmission resource configuration (e.g., frequency, bandwidth part, resource pool), a configuration requested to select the transmission resource (e.g., parameters applicable to the base station's scheduling resources or the UE1's own resource selection), power control for transmitting the sidelink discovery message, transmission parameters, retransmission parameters, modulation and coding scheme (MCS) information, a target service, target group, target destination, target PQI (PC5 5QI (5G QOS Identifier)) list, and target QoS parameter set list for the sidelink discovery message. In an embodiment of the present disclosure, the sidelink discovery message may be configured to be transmitted periodically. In an embodiment of the present disclosure, the sidelink discovery messages may be configured to be transmitted in one shot when a condition configured for the UE1 600 is satisfied, or may be configured to be transmitted at regular intervals. Of course, discovery messages may also be transmitted on an aperiodic basis.

FIG. 6b is a diagram illustrating a sidelink discovery procedure according to another embodiment of the present disclosure.

The UE3 650 is a relay user equipment (relay UE) that functions as a sidelink relay, and UE4 680 is a remote UE that performs data transmission and reception with a base station or other user equipment through the support of sidelink relay. The UE3 650 is a relay user equipment capable of obtaining authentication information or service information requested to perform sidelink relay-based communication. The authentication information or service information may be obtained from the core network or OAM method. UE4 680 is a remote user equipment capable of obtaining authentication information or service information requested to perform sidelink relay-based communication. The authentication information or service information may be obtained from the core network or OAM method. Authentication information or service information that allows UE3 650 and UE4 680 to perform sidelink relay discovery procedures may include the information in Table 1 above.

Alternatively, UE3 650 and UE4 680 illustrate the source user equipment and the target user equipment of the sidelink discovery procedure, respectively. UE3 650 and UE4 680 may obtain authentication or service information requested for sidelink discovery procedures through the core network or OAM method. Authentication information or service information that that can perform the sidelink discovery procedure may include the information in Table 2 above.

The UE4 680 may transmit a sidelink discovery message, for example, a second message, in step 651. The sidelink discovery message (second message) transmitted by UE4 680 in step 651 may include a discovery solicitation message. The UE4 680 may configure a second message and transmit the second message in step 651 if it is determined that the conditions for transmitting the second message are satisfied. In various embodiments, the second message may be transmitted for the purpose of searching for the relay user equipment to which the remote user equipment can relay the desired service message, or for the purpose of searching for the counterpart user equipment that the remote user equipment can provide the desired service to or participate in the service.

In the case that the UE3 650 determines that the second message has been received from the UE4 680, it may process the received second message. The UE3 650 may transmit a sidelink discovery message, such as a third message, in response to the second message. The sidelink discovery message (third message) may include a discovery message. In various embodiments, the third message may be used for the purpose of announcing the existence of a relay user equipment capable of relaying a service message desired by the remote user equipment when the relay user equipment receives the second message from the remote user equipment, or for the purpose of announcing the existence of a user equipment capable of providing or participating in a service desired by the remote user equipment when the user equipment receives the second message from the remote user equipment. In an embodiment, the UE3 650 may configure the third message in the case that the conditions for transmitting the third message are satisfied and may transmit the third message to the UE4 680 in step 653. The UE4 680 may process the third message in the case of receiving the third message transmitted from UE3 650. The UE3 650 and UE4 680 may obtain configuration information necessary to transmit and receive the sidelink discovery messages, for example, configuration information necessary to transmit and receive the first message, the second message, or the third message. The configuration information requested to receive the sidelink discovery messages may include at least one of a receiving resource configuration (e.g., frequency, bandwidth part, resource pool), a target service for the sidelink discovery messages, a target group, a target destination, a target PQI list, a target QoS parameter set list, a sidelink discovery message monitoring condition configuration, and a sidelink discovery message reception time window configuration information. The configuration information requested for sidelink discovery message transmission may include at least one of a transmission resource configuration (e.g., frequency, bandwidth part, resource pool), a configuration requested for selecting a transmission resource (e.g., scheduling resources of the base station or parameters applied by UE3 or UE4 for direct resource selection), a power control for sidelink discovery message transmission, a transmission parameter, a retransmission parameter, an MCS information, a target service of the sidelink discovery message, a target group, a target destination, a target PQI list, and a target QoS parameter set list.

In an embodiment of the present disclosure, the sidelink discovery message may be configured to be transmitted periodically. In an embodiment of the present disclosure, the sidelink discovery message may be configured to be transmitted in one shot when the conditions configured for UE3 650 and UE4 680 are satisfied, or to be transmitted at a regular interval.

As described with reference to the embodiment of the FIGS. 6a to 6b, a transmission pool resource for user equipment (including the relay user equipment, the remote user equipment) to transmit a sidelink discovery message must be configured, and the user equipment may transmit the sidelink discovery message by receiving an allocation of the resource of the sidelink discovery message transmission resource pool from the base station or by selecting by itself. The resource pool for transmitting sidelink discovery messages may be configured as follows.

(1) configured to be shared with the general sidelink communication transmission resource pool (shared resource pool): The general sidelink communication transmission resource pool may or may not include PSFCH (Physical Sidelink Feedback Channel), which is a HARQ feedback transmission resource. In the case that one or more general sidelink communication transmission resource pools are configured, at least one general sidelink communication transmission resource pool is configured to include the PSFCH. In the case that a sidelink discovery message is used for unicast or groupcast purposes and requests HARQ feedback, a general sidelink communication transmission resource pool with PSFCH configured may be configured and allocated as a shared resource pool to transmit the corresponding sidelink discovery message.

(2) Configured as a transmission pool dedicated to the sidelink discovery message (dedicated resource pool): This resource pool cannot be used for general sidelink communication transmission, but can be configured to be used only for transmitting sidelink discovery messages. Most of sidelink discovery messages can be used for broadcast purposes, or unicast or groupcast purposes that do not request HARQ feedback. Therefore, for sidelink discovery messages that do not request HARQ feedback, a dedicated transmission resource pool for sidelink discovery messages for which PSFCH is not configured can be configured and allocated to the user equipment.

The base station may configure and allocate to the user equipment a transmission resource pool for transmitting sidelink discovery messages, wherein the base station may configure and allocate to the user equipment one of the following transmission resource pools: a transmission resource pool dedicated to sidelink discovery messages, a pool shared with the general sidelink communication transmission resource pool, or two transmission resource pools. In the case that the base station configures and allocates two transmission resource pools to the user equipment or allocates one of the two resource pools, the base station may receive a report about sidelink discovery messages from the user equipment as auxiliary information to determine which transmission resource pool to configure and allocate. The information about the sidelink discovery message may include at least one or a combination of, for example, information about a sidelink discovery procedure, that is, information of a discovery model or a sidelink relay discovery model, and information about whether the sidelink discovery message requests HARQ feedback. The auxiliary information at the user equipment may correspond to information indicating whether the PSFCH transmission resource allocated transmission resource pool for the HARQ feedback is requested. For example, in the case that it is determined that it is necessary to transmit HARQ feedback for sidelink discovery messages and that PSFCH transmission resources for HARQ feedback are requested, the base station may configure and allocate to the user equipment a pool shared with the general sidelink communication transmission resource pool in which PSFCH transmission resources are configured for sidelink discovery message transmission. For example, in the case that it is determined that it is not necessary to transmit HARQ feedback for sidelink discovery messages and that PSFCH transmission resources for HARQ feedback are not requested, the base station may configure and allocate to the user equipment a transmission resource pool dedicated to sidelink discovery messages with no PSFCH transmission resources configured for sidelink discovery message transmission. The user equipment may determine which sidelink discovery procedure is applicable for the sidelink discovery message, that is, information about the discovery model or sidelink relay discovery model, information about whether the sidelink discovery message requests HARQ feedback, or information about the range requests for the sidelink discovery message, based on the authentication information or service information in Table 1 to Table 2 above. In this way, the user equipment may report to the base station the auxiliary information for transmitting the sidelink discovery message determined based on the authentication information or service information in Tables 1 to 2.

In an example where information about the sidelink discovery procedure, that is, the discovery model or the sidelink relay discovery model, is used as auxiliary information that the user equipment reports to the base station, the sidelink discovery messages used in the sidelink discovery procedure may be transmitted for broadcast purposes if the user equipment transmits sidelink discovery messages based on the sidelink discovery procedure of FIG. 6a. In this case, the sidelink discovery message may not request HARQ feedback and may be transmitted from the sidelink discovery message transmission resource pool for which PSFCH is not configured. Therefore, the base station may configure and allocate to the user equipment a transmission resource pool dedicated to sidelink discovery messages without PSFCH. To do so, the base station needs to know information about whether the user equipment uses the sidelink discovery procedure of FIG. 6a or whether the sidelink discovery messages transmitted by the user equipment request HARQ feedback, and the information may be provided to the base station by the user equipment that wants to transmit the sidelink discovery messages. In another example of using information about the sidelink discovery procedure, that is, the discovery model or the sidelink relay discovery model, as an auxiliary information that the user equipment reports to the base station, in the case that the user equipment transmits a sidelink discovery message based on the sidelink discovery procedure of FIG. 6b, the sidelink discovery message may be transmitted for unicast to a specific relay user equipment or to a specific user equipment. In this case, the sidelink discovery message may request HARQ feedback and may be transmitted from the sidelink discovery message transmission resource pool for which the PSFCH is configured. Therefore, the base station may configure and allocate to the user equipment a pool that is shared with the general sidelink communication transmission resource pool for which the PSFCH is configured. To do this, the base station needs to know information about whether the user equipment uses the sidelink discovery procedure of FIG. 6b or whether the sidelink discovery message transmitted by the user equipment requests HARQ feedback, and the information may be provided to the base station by the user equipment that wants to transmit the sidelink discovery message.

As another embodiment of using the sidelink discovery procedure, that is, information about the discovery model or sidelink relay discovery model as an auxiliary information that the user equipment reports to the base station, for example, in the case that the user equipment transmits a sidelink discovery message based on the sidelink discovery procedure of FIG. 6a, the sidelink discovery message used in the sidelink discovery procedure may be transmitted for groupcast purposes. In the case that the user equipment transmits a sidelink discovery message based on the sidelink discovery procedure of FIG. 6b, the sidelink discovery message may be transmitted for groupcast to a specific relay user equipment or to a specific user equipment. In the case of transmitting a sidelink discovery message for groupcast purposes in the sidelink discovery procedure of FIG. 6a to FIG. 6b, the user equipment may determine the range request configured for the sidelink discovery message of discovery model A or discovery model B, and in the case that the range request is configured, the user equipment may determine that HARQ feedback is requested for the sidelink discovery message, and in the case that the range request is not configured, the user equipment may determine that HARQ feedback is not requested. The user equipment may report information about the range request or information about the HARQ feedback request to the base station in the case that the range request is configured for sidelink discovery messages in discovery model A or discovery model B. The base station may determine that HARQ feedback is not requested in the case that the range request is not configured or in the case that the HARQ feedback request is not configured, and the base station may configure and allocate to the user equipment a transmission resource pool dedicated to sidelink discovery messages without PSFCH. The base station may configure and allocate to the user equipment a pool that is shared with the general sidelink communication transmission resource pool with PSFCH configured, in the case that the base station determines that HARQ feedback is requested, either because a range request is configured or because the base station determines that HARQ feedback is requested. In the sidelink discovery message transmission resource pool configured and allocated by the base station, the user equipment may allocate transmission resources based on information about the sidelink discovery procedure of the sidelink discovery message, that is, the discovery model or the sidelink relay discovery model, and information about whether the sidelink discovery message requests HARQ feedback. Here, the operation of the user equipment allocating a transmission resource may mean sensing a transmission resource pool configured and allocated by the base station and selecting a transmission resource that the user equipment can actually use to transmit the sidelink discovery message.

In an example of using information about whether a sidelink discovery message requests HARQ feedback as auxiliary information that the user equipment reports to the base station, the user equipment may determine whether HARQ feedback is requested for a sidelink discovery message to be transmitted based on the authentication information or service information in Tables 1 to 2 above. In the case that the user equipment determines that the sidelink discovery message requests HARQ feedback and needs to be transmitted from the sidelink discovery message transmission resource pool for which the PSFCH is configured, the user equipment may inform the base station of the need to transmit HARQ feedback. Therefore, the base station may configure and allocate the user equipment a pool shared with the general sidelink communication transmission resource pool with PSFCH configured. In the case that the user equipment determines that the sidelink discovery message does not request HARQ feedback and does not need to be transmitted from the sidelink discovery message transmission resource pool for which the PSFCH is configured, the user equipment may inform the base station that HARQ feedback transmission is not requested. Therefore, the base station may configure and allocate the user equipment a transmission resource pool dedicated to sidelink discovery messages without PSFCH.

In an example where a range request is configured for sidelink discovery messages and the user equipment uses information about whether HARQ feedback from a remote user equipment that meets the range requirement is requested for sidelink discovery messages as auxiliary information that the user equipment reports to the base station, in the case that the user equipment has a range requirement configured for the sidelink discovery message and determines that a remote user equipment that satisfies the range requirement needs to transmit HARQ feedback for the sidelink discovery message, the user equipment may inform the base station of the need to transmit HARQ feedback by determining that the sidelink discovery message requests HARQ feedback and needs to be transmitted from the sidelink discovery message transmission resource pool for which the PSFCH is configured. At this time, the user equipment may inform the base station that HARQ feedback transmission is requested as information that a range requirement applies. Therefore, the base station may configure and allocate the user equipment a pool that is shared with the general sidelink communication transmission resource pool with PSFCH configured. In the case that the user equipment determines that no range request is configured for the sidelink discovery message and that HARQ feedback is not requested for the sidelink discovery message, the user equipment may inform the base station that HARQ feedback transmission is not requested by determining that the sidelink discovery message can be transmitted from a sidelink discovery message transmission resource pool that does not request HARQ feedback and does not have PSFCH configured. In this case, the user equipment may inform the base station that no HARQ feedback transmission is requested by informing the base station that the range requirement does not apply. Therefore, the base station may configure and allocate a transmission resource pool dedicated to sidelink discovery messages without PSFCH to the user equipment.

On the other hand, even when the auxiliary information of the user equipment, that is, the sidelink discovery procedure, that is, information about the discovery model or sidelink relay discovery model, and information about whether the sidelink discovery message requests HARQ feedback, are obtained, regardless of the auxiliary information, the base station may still configure and allocate to the user equipment a transmission resource pool without PSFCH for HARQ feedback or configure and allocate to the user equipment a transmission resource pool with PSFCH for HARQ feedback.

To assist the base station in determining whether the user equipment should configure and allocate a dedicated transmission resource pool for sidelink discovery messages for transmission of sidelink discovery messages or configure and allocate to share a common sidelink communication transmission resource pool, the message used by the user equipment to report information about the sidelink discovery procedure or HARQ feedback information of the sidelink discovery message to the base station may include the information in the following Table 3. The message used by the user equipment to request sidelink discovery message transmission resources may include, in addition to the destination identification information, cast type information, and frequency information of the sidelink discovery message, information on whether the sidelink discovery procedure of interest to the user equipment is Model A (FIG. 6a) or Model B (FIG. 6b), and information on whether the sidelink discovery message requests HARQ feedback. The message may be a SidelinkUEInformationNR. In the case that the base station obtains the SidelinkUEInformationNR message, which is used by the user equipment to request sidelink discovery message transmission resources, the base station shall obtain the destination identification information of the sidelink discovery message, the cast type information, frequency information, model information of the sidelink discovery procedure or information on whether HARQ feedback is provided, and based on the information in the SidelinkUEInformationNR message, the transmission resource pool to be used by the user equipment to transmit the sidelink discovery message may be configured and allocated as a transmission resource pool dedicated to the sidelink discovery message, or may be configured and allocated to share the general sidelink communication transmission resource pool. The user equipment may allocate transmission resources from the sidelink discovery message transmission resource pool configured and allocated by the base station based on information about the sidelink discovery procedure of the sidelink discovery message, that is, the discovery model or the sidelink relay discovery model, and information about whether the sidelink discovery message requests HARQ feedback. Here, the operation of the user equipment allocating a transmission resource may mean sensing a transmission resource pool configured and allocated by the base station and selecting a transmission resource that the user equipment can actually use to transmit the sidelink discovery message.

TABLE 3
SidelinkUEInformationNR-IEs ::= SEQUENCE {

| | |
|---|---|
| sl-RxInterestedFreqList SL-InterestedFreqList | OPTIONAL, |
| sl-TxResourceReqList SL-TxResourceReqList | OPTIONAL, |
| lateNonCriticalExtension OCTET STRING | OPTIONAL, |
| nonCriticalExtension SEQUENCE { } | OPTIONAL |

```
}
SL-InterestedFreqList ::= SEQUENCE (SIZE (1..maxNrofFreqSL)) OF INTEGER
(1..maxNrofFreqSL)
SL-TxResourceReqList ::= SEQUENCE (SIZE (1..maxNrofSL-Dest)) OF SL-TxResourceReq
SL-TxResourceReq ::= SEQUENCE {
  sl-DestinationIdentity SL-DestinationIdentity,
  sl-CastType ENUMERATED {broadcast, groupcast, unicast, spare1},
  sl-DiscoveryModelIndication //modelA [symbol]   modelB [symbol] [symbol] [symbol] [symbol] [symbol]
  sl-HARQFeedbackRequired ENUMERATED {true} OPTIONAL,
  sl-RangeRequirementApplied ENUMERATED {true} OPTIONAL,
  sl-TxInterestedFreqList SL-TxInterestedFreqList OPTIONAL,
  ...
}
SL-TxInterestedFreqList ::= SEQUENCE (SIZE (1..maxNrofFreqSL)) OF INTEGER
(1..maxNrofFreqSL)
```

For convenience of explanation, Table 3 above describes sl-DiscoveryModelIndication, sl-HARQFeedbackReqired, and sl-RangeRequirementApplied as all being included in the SidelinkUEInformationNR message, but at least one parameter of sl-DiscoveryModelIndication, sl-HARQFeedbackRequired, and sl-RangeRequirementApplied, may be used as information about whether a sidelink discovery message from the user equipment requests PSFCH configuration, and at least one of the parameters may be included in the SidelinkUEInformationNR message and transmitted to the base station. The sl-DiscoveryModelIndication may be used as a parameter to indicate whether the discovery procedure corresponding to the sidelink discovery message to be transmitted by the user equipment corresponds to discovery model A or discovery model B. In the case that the user equipment needs to use both discovery model A and discovery model B, the user equipment may configure the sl-DiscoveryModelIndication parameter to indicate to the base station that it uses both discovery model A and discovery model B. The base station may configure the sl-DiscoveryModelIndication parameter to indicate that it uses both discovery model A and discovery model B. The base station may configure and allocate to the user equipment a transmission resource pool dedicated to sidelink discovery messages with no PSFCH configured because it does not request HARQ feedback transmission for sidelink discovery messages in the case that discovery model A is indicated, or it may configure and allocate to the user equipment to share a common sidelink communication transmission resource pool with PSFCH configured because it may request HARQ feedback transmission for sidelink discovery messages in the case that discovery model B is indicated. HARQFeedbackRequired may be used as a parameter to indicate whether the sidelink discovery message to be transmitted by the user equipment requests HARQ feedback. The base station may configure and allocate to the user equipment a transmission resource pool dedicated to sidelink discovery messages without PSFCH configured in the case that HARQFeedbackRequired is determined to be false, that is, HARQ feedback is not requested for the sidelink discovery messages, and may configure and allocate to the user equipment to share a general sidelink communication transmission resource pool with PSFCH configured in the case that HARQFeedbackRequired is determined to be true, that is, HARQ feedback transmission may be requested for the sidelink discovery messages.

Since the sl-RangeRequirementApplied requests remote user equipments within the range requested by the sidelink discovery message to be able to transmit HARQ feedback in the case of transmitting sidelink discovery messages based on groupcast, the sl-RangeRequirementApplied parameter may be used as a parameter to indicate whether the sidelink discovery message to be transmitted by the user equipment requests HARQ feedback. The base station may configure and allocate to the user equipment a transmission resource pool dedicated to sidelink discovery messages with no PSFCH configured in the case that RangeRequirementApplied is determined to be false, that is, HARQ feedback is not requested for sidelink discovery messages, and may configure and allocate to the user equipment to share a common sidelink communication transmission resource pool with PSFCH configured in the case that RangeReqirementApplied is determined to be true, that is, HARQ feedback transmission may be requested for sidelink discovery messages.

In the case of [Table 3] above, an embodiment of the information that may be included in the SidelinkUEInformationNR message and transmitted to the base station that may be used as information about whether the sidelink discovery message from the user equipment requests PSFCH configuration, that is, whether the sidelink discovery message requests HARQ feedback, may include the sl-DiscoveryIntegratedIndication parameter that indicates whether the sidelink discovery message is integrated with the sidelink unicast link configuration message. In the case that the sl-DiscoveryIntegratedIndication parameter is configured to be true, the base station may determine that a sidelink unicast link configuration message is transmitted with a sidelink discovery message and may request the transmission of HARQ feedback for the sidelink discovery message as well, and may therefore configure and allocate the user equipment to share a common pool of sidelink communication transmission resources for which the PSFCH is configured. In the case that the sl-DiscoveryIntegratedIndication parameter is configured to be false (or in the case that the sl-DiscoveryIntegratedIndication parameter is not included in the SidelinkUEInformationNR message), the base station may determine that the sidelink discovery message is not integrated with the sidelink unicast link configuration message. In an example of when a sidelink discovery message may be integrated into a sidelink unicast link configuration message, a Direct Connection Request message and a Direct Connection Accept message, etc. exchanged to configure a sidelink unicast link between user equipment A and user equipment B may include at least one or a combination of the discovery information for user equipment B and user equipment A, and the relay information that may relay communication between user equipment B and user equipment A. At this time, in the case that HARQ feedback is applied to the messages of the sidelink unicast link configuration procedure exchanged between the two user equipments, HARQ feedback may also be applied to the sidelink discovery messages contained in these messages, so it is necessary to allocate a resource pool containing PSFCHs corresponding to the HARQ feedback transmission resources to the user equipment that transmitted the SidelinkUEInformationNR message.

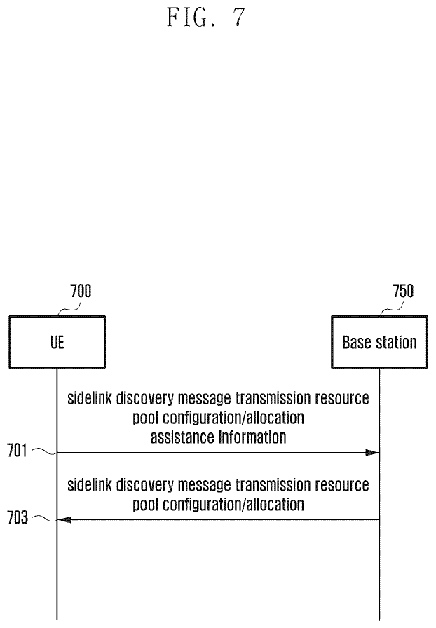

FIG. 7 is a diagram illustrating signal flow between a user equipment and a base station that assists in allocating a transmission resource pool for a sidelink discovery message according to an embodiment of the present disclosure.

With reference to FIG. 7, in the case that the user equipment 700 determines that configuring and allocating a transmission resource pool to transmit the sidelink discovery message is necessary, it may transmit a message, to the base station 750 in step 701, that includes the information in Table 3 above, including information about the sidelink discovery procedure for the sidelink discovery message, that is, information about the discovery model or sidelink relay discovery model, and information about whether the sidelink discovery message requests HARQ feedback. The message may be a SidelinkUEInformationNR message. The user equipment 700 may determine and obtain the information requested to constitute the SidelinkUEInformationNR message including the information in Table 3 based on the information in Tables 1 and 2 above. Based on the information in the SidelinkUEInformationNR message received in step 701, the base station 750 may configure and allocate the user equipment 700 a transmission resource pool to be used to transmit the sidelink discovery message in step 703 as a transmission resource pool dedicated to sidelink discovery messages or may configure and allocate to share a general sidelink communication transmission resource pool. For example, the base station 750 may configure and allocate to the user equipment a transmission resource pool dedicated to sidelink discovery messages with no PSFCH configured in the case that the base station 750 determines that HARQ feedback is not requested for sidelink discovery messages, or it may configure and allocate the user equipment to share a common sidelink communication transmission resource pool with PSFCH configured in the case that base station 750 determines that HARQ feedback is requested for sidelink discovery messages because transmission of HARQ feedback may be requested. The base station 750 may configure and allocate either or both transmission resource pools to the user equipment 700 in step 703.

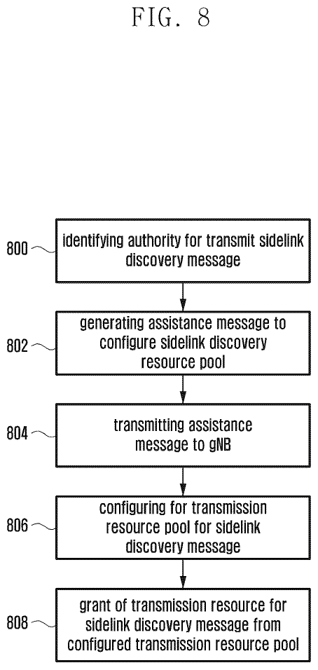

FIG. 8 is a diagram illustrating the operation of a user equipment that assists in allocating a transmission resource pool for a sidelink discovery message according to an embodiment of the present disclosure.

With reference to FIG. 8, in step 800, the user equipment may determine, based on the information in Table 1 or Table 2, a sidelink discovery procedure for the sidelink discovery message, that is, information about a discovery model or a sidelink relay discovery model, and information about whether the sidelink discovery message requests HARQ feedback. In step 802, the user equipment may constitute a message that includes at least one or a combination of information that may assist in configuring and allocating a sidelink discovery message transmission resource pool, that is, information about the discovery model or sidelink relay discovery model, and information about whether the sidelink discovery message requests HARQ feedback. For example, the user equipment may constitute a SidelinkUEInformationNR message including the information in Table 3. In step 804, the user equipment may transmit a message to the base station to assist in configuring and allocating the sidelink discovery message transmission resources constituted in step 802. In step 806, the user equipment may receive from the base station the configuration and allocation of a sidelink discovery message transmission resource pool. The sidelink discovery message transmission resource pool that the base station configures and allocates to the user equipment in step 806 may include at least one or a combination of a dedicated sidelink discovery message transmission resource pool and a pool shared with a general sidelink communication transmission resource pool. The transmission resource pool dedicated to the sidelink discovery message that the base station may configure and allocate to the user equipment in step 806 may not have HARQ feedback transmission resources configured, and the pool shared with the general sidelink communication transmission resource pool may have HARQ feedback transmission resources configured. In step 808, the user equipment may allocate transmission resources from the sidelink discovery message transmission resource pool configured and allocated by the base station based on information about the sidelink discovery procedure of the sidelink discovery message, that is, the discovery model or the sidelink relay discovery model, and information about whether the sidelink discovery message requests HARQ feedback. Here, the operation of the user equipment allocating a transmission resource may mean sensing a transmission resource pool configured and allocated by the base station and selecting a transmission resource that the user equipment can actually use to transmit the sidelink discovery message.

On the other hand, in the embodiments of FIGS. 7 to 8, the user equipment assists in configuring and allocating a transmission resource pool for a sidelink discovery message in the RRC CONNECTED state in which an RRC connection with a base station is configured, and configures an operation for configuring and receiving a transmission resource pool. In the case that the user equipment is in the RRC_IDLE state or the RRC_INACTIVE state, the user equipment may receive a configuration and allocation of at least one or a combination of a transmission resource pool dedicated to sidelink discovery messages and a pool shared with the general sidelink communication transmission resource pool through a system information message (SIB) transmitted by the base station, or in the case that the user equipment is in the out-of-coverage state, the user equipment may receive a configuration and allocation of at least one or a combination of a transmission resource pool dedicated to sidelink discovery messages and a pool shared with the general sidelink communication transmission resource pool through pre-configured pre-configuration information. In the case that the user equipment is in the RRC_IDLE state or the RRC_INACTIVE state, or in an out-of-coverage state, the user equipment may perform a sidelink discovery procedure of the sidelink discovery message in the sidelink discovery message transmission resource pool configured and allocated by the base station, that is, an operation of selecting one of a transmission resource pool dedicated to the sidelink discovery message and a pool shared with the general sidelink communication transmission resource pool, based on the sidelink discovery procedure, that is, information about the discovery model or the sidelink relay discovery model, information about whether the sidelink discovery message requests HARQ feedback, and information about whether the sidelink discovery message requests HARQ feedback based on the range requirements of the sidelink discovery message. For example, in the case that it is determined that the sidelink discovery message requests HARQ feedback, the user equipment may select a pool that is shared with the general sidelink communication transmission resource pool in which the HARQ feedback transmission resource is configured. For example, in the case that the user equipment determines that the sidelink discovery message does not request HARQ feedback, the user equipment may select a transmission resource pool dedicated to sidelink discovery messages that does not have a HARQ feedback resource configured. The user equipment may allocate the transmission resources requested for the sidelink discovery message from the selected pool. Here, the operation of the user equipment allocating transmission resources may mean sensing the transmission resource pool configured and allocated by the base station and selecting the transmission resources that the user equipment can actually use to transmit the sidelink discovery message.

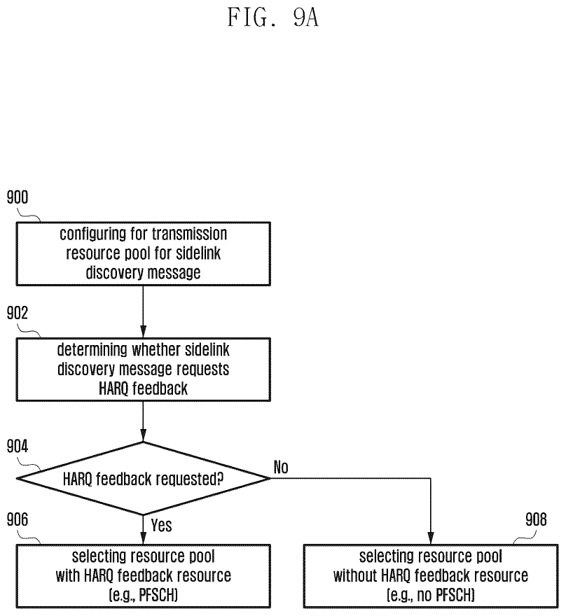

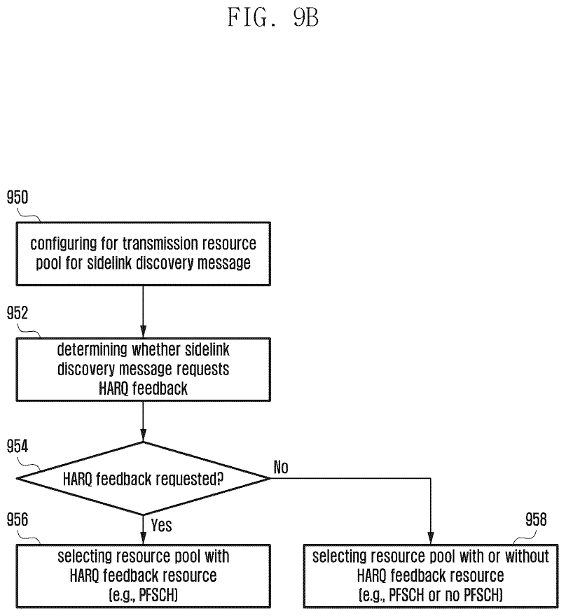

FIG. 9a is a diagram illustrating the operation of a user equipment to select a transmission resource pool for a sidelink discovery message according to an embodiment of the present disclosure.

With reference to FIG. 9a, the user equipment may receive a sidelink discovery message transmission resource pool configured and allocated from the base station in step 900. The sidelink discovery message transmission resource pool configured and allocated by the base station in step 900 may be one of a transmission resource pool dedicated to sidelink discovery messages and a pool shared with a general sidelink communication transmission resource pool, or may include both transmission resource pools. In step 902, the user equipment may determine the sidelink discovery procedure of the sidelink discovery message, such as information about the discovery model or the sidelink relay discovery model, information about whether the sidelink discovery message requests HARQ feedback, and information about whether the sidelink discovery message requests HARQ feedback based on the range requirements of the sidelink discovery message. In the case that the user equipment determines in step 904 that the sidelink discovery message requests HARQ feedback, the user equipment may select a transmission resource pool that has a HARQ feedback transmission resource (e.g., PSFCH) configured in step 906. For example, the user equipment may select a pool that is shared with a common sidelink communication transmission resource pool that has a HARQ feedback transmission resource configured. If the user equipment determines in step 904 that the sidelink discovery message does not request HARQ feedback, the user equipment may select in step 908 a transmission resource pool that does not have a HARQ feedback transmission resource (e.g., PSFCH) configured. For example, the user equipment may select a transmission resource pool dedicated to sidelink discovery messages for which no HARQ feedback transmission resource is configured. The user equipment may allocate the transmission resources requested for the sidelink discovery messages from the selected pool in step 906 or step 908. Here, the operation of the user equipment allocating transmission resources may mean sensing the transmission resource pool configured and allocated by the base station and selecting the transmission resources that the user equipment can actually use to transmit the sidelink discovery message.

FIG. 9b is a diagram illustrating an operation of a user equipment to select a transmission resource pool for a sidelink discovery message according to another embodiment of the present disclosure.

With reference to FIG. 9b, the user equipment may receive a sidelink discovery message transmission resource pool configured and allocated from the base station in step 950. The sidelink discovery message transmission resource pool configured and allocated by the base station in step 950 may be one of a transmission resource pool dedicated to sidelink discovery messages and a pool shared with a general sidelink communication transmission resource pool, or may include both transmission resource pools. In step 952, the user equipment may determine the sidelink discovery procedure of the sidelink discovery message, such as information about the discovery model or the sidelink relay discovery model, information about whether the sidelink discovery message requests HARQ feedback, and information about whether the sidelink discovery message requests HARQ feedback based on the range requirements of the sidelink discovery message. In the case that the user equipment determines in step 954 that the sidelink discovery message requests HARQ feedback, the user equipment may select a transmission resource pool that has a HARQ feedback transmission resource (e.g., PSFCH) configured in step 956. For example, the user equipment may select a pool that is shared with a common sidelink communication transmission resource pool that has a HARQ feedback transmission resource configured. In the case that the user equipment determines in step 954 that the sidelink discovery message does not request HARQ feedback, the user equipment may arbitrarily select a transmission resource pool in step 958 over which the sidelink discovery message can be transmitted regardless of whether the HARQ feedback transmission resource is configured. For example, the user equipment may select a pool that is shared with the general sidelink communication transmission resource pool that has the HARQ feedback transmission resource configured, or the user equipment may select a transmission resource pool that is dedicated to sidelink discovery messages that does not have the HARQ feedback transmission resource configured. The user equipment may allocate the transmission resources requested for the sidelink discovery messages from the selected pool in step 956 or step 958. Here, the operation of the user equipment allocating transmission resources may mean sensing the transmission resource pool configured and allocated by the base station and selecting the transmission resources that the user equipment can actually use to transmit the sidelink discovery message.

Methods according to embodiments described in the claims or specification of the present disclosure may be implemented in the form of hardware, software, or a combination of hardware and software.

In case of a software implementation, a computer-readable storage medium that stores one or more programs (software modules) may be provided. One or more programs stored in a computer-readable storage medium are configured to be executable by one or more processors in an electronic device (configured for execution). One or more programs include instructions that enable the electronic device to execute methods according to embodiments described in the claims or specification of the present disclosure.

These programs (software modules, software) may be stored in random access memory, non-volatile memory including flash memory, read only memory (ROM), and electrically erasable programmable read only memory (EEPROM), magnetic disc storage device, Compact Disc-ROM (CD-ROM), Digital Versatile Discs (DVDs), or other types of optical storage device or magnetic cassette. Alternatively, it may be stored in a memory consisting of a combination of some or all of these. In addition, each configuration memory may include multiple units.

In addition, the program may be stored on an attachable storage device that can be accessed via a communications network such as the Internet, intranet, local area network, wide LAN, or storage area network (SAN), or a communication network constituting of a combination thereof. Such storage device may be connected to the device performing the embodiment of the present disclosure through an external port. In addition, a separate storage device on the communication network may be connected to the device performing the embodiment of the present disclosure.

In the specific embodiments of the present disclosure described above, components included in the disclosure are expressed in singular or plural numbers depending on the specific embodiment presented. However, as the singular or plural expressions are selected to suit the presented situation for convenience of explanation, the present disclosure is not limited to singular or plural components, and even the components expressed in plural may be composed of the singular elements and even components expressed in singular may be composed of plural elements.

On the other hand, the detailed description of the present disclosure has described specific embodiments, but of course, various modifications are possible without departing from the scope of the present disclosure. Therefore, the scope of the present disclosure should not be confined to the embodiments described, but should be determined not only by the scope of the patent claims described below, but also by the scope of this patent claim and equivalents.

1. A method performed by a first user equipment (UE) in a wireless communication system, the method comprising:
receiving, from a second UE, a first sidelink discovery message;
determining whether Hybrid Automatic Repeat and request (HARQ) feedback is requested based on the first sidelink discovery message; and
transmitting, to the second UE, a second sidelink discovery message including information indicating the HARQ feedback based on the determination.

2. The method of claim 1, further comprising:
transmitting, to a base station, a first message including information on whether the second sidelink discovery message requests the HARQ feedback; and
receiving, from the base station, a second message including a resource pool for transmitting the HARQ feedback.

3. The method of claim 1, wherein:
a first message requesting a resource pool for transmitting the first sidelink discovery message is transmitted from the second UE to the base station; and
a second message including the resource pool is transmitted from the base station to the second UE.

4. The method of claim 2, wherein the first message further comprises cast type information.

5. A method performed by a second user equipment (UE) in a wireless communication system, the method comprising:
transmitting, to a first UE, a first sidelink discovery message;
receiving, from the first UE, a second sidelink discovery message including information indicating HARQ (Hybrid Automatic Repeat and request) feedback; and
determining whether the HARQ feedback is requested based on the information indicating the HARQ feedback.

6. The method of claim 5, further comprising:
transmitting, to the first UE, the HARQ feedback based on the information indicating the HARQ feedback.

7. The method of claim 5, further comprising:
transmitting, to a base station, a first message requesting a resource pool for transmitting the first sidelink discovery message; and
receiving, from the base station, a second message including the resource pool.

8. The method of claim 6, wherein the first message further comprises cast type information.

9. A first user equipment (UE) comprising:
a transceiver capable of transmitting and receiving at least one signal; and
a controller coupled to the transceiver, wherein
the controller is configured to:
receive, from a second UE, the first sidelink discovery message,
determine whether HARQ (Hybrid Automatic Repeat and request) feedback is requested based on the first sidelink discovery message, and
transmit, to the second UE, a second sidelink discovery message including information indicating the HARQ feedback based on the determination.

10. The first UE of claim 9, wherein the controller is further configured to:
transmit, to a base station, a first message including information on whether the second sidelink discovery message requests the HARQ feedback, and
receive, from the base station, a second message including a resource pool for transmitting the HARQ feedback.

11. The first UE of claim 9, wherein:
a first message requesting a resource pool for transmitting the first sidelink discovery message is transmitted from the second UE to the base station, and
a second message including the resource pool is transmitted from the base station to the second UE.

12. The first UE of claim 10, wherein the first message further comprises cast type information.

13. A second user equipment (UE) comprising:
a transceiver capable of transmitting and receiving at least one signal; and
a controller coupled to the transceiver, wherein
the controller is configured to:
transmit, to a first UE, the first sidelink discovery message,
receive, to the first UE, the second sidelink discovery message including information indicating HARQ (Hybrid Automatic Repeat and request) feedback, and
determine whether the HARQ feedback is requested based on the information indicating the HARQ feedback.

14. The second UE of claim 13, wherein the controller is further configured to: transmit, to the first UE, the HARQ feedback based on the information indicating the HARQ feedback.

15. The second UE of claim 13, wherein the controller is further configured to: transmit, to a base station, a first message requesting a resource pool for transmitting the first sidelink discovery message to the base station, and
receive, from the base station, a second message including the resource pool from the base station.
